(19) United States
(12) Patent Application Publication
(10) Pub. No.: US 2024/0411120 A1
(43) Pub. Date: Dec. 12, 2024

(54) BRIGHT-FIELD REFLECTION MICROSCOPE, OBSERVATION METHOD, AND PROGRAM

(71) Applicant: NIKON CORPORATION, Tokyo (JP)

(72) Inventors: Naoki FUKUTAKE, Tokyo (JP); Satoshi IKEDA, Yokohama-shi (JP)

(73) Assignee: NIKON CORPORATION, Tokyo (JP)

(21) Appl. No.: 18/808,555

(22) Filed: Aug. 19, 2024

Related U.S. Application Data
(63) Continuation of application No. PCT/JP2022/016018, filed on Mar. 30, 2022.

(51) Int. Cl. G02B 21/08; G02B 21/12; G02B 21/36

(52) U.S. Cl. CPC G02B 21/084; G02B 21/12; G02B 21/365

(57) ABSTRACT

A bright-field reflection microscope according to the present embodiment includes an illumination optical system that includes an aperture pattern turret that can form a plurality of annular illumination lights having annulus radiuses different from each other and an objective lens and illuminates the sample S with the illumination light; a detection optical system that gathers a first reflected light from the sample S and a second reflected light from an interface of surroundings of the sample S at the capturing device via the objective lens; and a control unit, and the capturing device detects the first reflected light and the second reflected light at each of the plurality of positions with different relative positions to the objective lens and the sample S by using each of the plurality of annular illumination lights formed by the control unit controlling the aperture pattern turret.

The contents of the following patent application(s) are incorporated herein by reference:
NO. PCT/JP2022/016018 filed in WO on Mar. 30, 2022

### BACKGROUND

### 1. Technical Field

The present invention relates to a bright-field reflection microscope, an observation method, and a program.

### 2. Related Art

Conventionally, a bright-field microscope is an optical device to observe an illuminated sample by magnifying it using an objective lens and attracts attention as a quantitative phase microscope due to the recent technological developments of a two-dimensional detector (for example, see Non-Patent Document 1). The bright-field microscope is not only used to observe an absorbing object but also a phase object. With the bright-field reflection microscope, when a sample is illuminated by using, for example, typical illumination such as Köhler illumination, a reflected diffraction light from the sample, which is affected by the structure of the sample (hereinafter, referred to as the reflected light from the sample), interferes with a reflected light from an interface of the surroundings of the sample, for example, a cover glass that holds the sample, which is not affected by the structure of the sample and thus an object image is formed. However, because the phase of the reflected light from the cover glass shifts due to the cover glass being driven in the optical axis direction together with the sample, spurious resolution occurs in a three-dimensional image of the sample.
Non-Patent Document 1: NATURE COMMUNICATIONS (2019) 10:4691

### BRIEF DESCRIPTION OF THE DRAWINGS

FIG. 1A shows a schematic arrangement of a bright-field reflection microscope according to the present embodiment.

FIG. 1B shows that when a sample is illuminated, a reflected light from the sample and a reflected light from the interface of the surroundings of the sample are generated.

FIG. 1C shows the schematic arrangement of an aperture pattern turret.

FIG. 1D shows the shape of an effective light source generated by an illumination optical system.

FIG. 2A shows a three-dimensional shape (a pupil function) of an imaging pupil P_{col}(f) and an illumination pupil Pᵢₗₗ(f) in a frequency space.

FIG. 2B shows the fx-fz and fx-fy two-dimensional shapes (pupil function) of the imaging pupil P_{col}(f) and the illumination pupil Pᵢₗₗ(f) in the frequency space.

FIG. 2C shows a three-dimensional aperture A (f) given by the convolution of the imaging pupil P_{col}(f) and the illumination pupil Pᵢₗₗ(f).

FIG. 2D shows a three-dimensional aperture ΣᵢAᵢ(f) in the case of the number M of annuluses being five.

FIG. 3A shows an example of a set of the imaging pupil P_{col}(f) and a plurality of annulus pupils P_{ill,i} having annulus radiuses different from each other obtained by dividing the illumination pupil Pᵢₗₗ(f).

FIG. 3B shows a three-dimensional aperture Aᵢ(f) of the annulus illumination obtained from each set of the imaging pupil P_{col}(f) and the annulus pupil P_{ill,i} shown in FIG. 3A.

FIG. 3C shows a three-dimensional aperture Bᵢ(f) obtained by shifting each of the three-dimensional apertures Aᵢ(f) of the annulus illumination shown in FIG. 3B in the +fz direction.

FIG. 3D shows the total sum of three-dimensional apertures Bᵢ(f) of the annulus illuminations shown in FIG. 3C.

FIG. 4 shows a positive-definite function calculated by using the three-dimensional aperture Bᵢ(f) of the annulus illumination shown in FIG. 3C.

FIG. 5 shows an image frequency region iA′ᵢ(f) obtained as a result of extracting only a positive value region shown in FIG. 4 from an image frequency, obtained by using each annulus illumination (a frequency space image obtained through a Fourier transform of a three-dimensional image), and shifting it in the −fz direction.

FIG. 6 shows a distribution Σᵢ{iA′ᵢ(f)−iA′*ᵢ(−f)} of an object frequency of an observable phase object by using the image frequency region iA′ᵢ(f) shown in FIG. 5.

FIG. 7A shows an object image reconstructed through an image processing method according to the present embodiment.

FIG. 7B shows an object image according to a comparative example.

FIG. 8 shows the flow of an observation method using the bright-field reflection microscope according to the present embodiment.

FIG. 9 shows an example of an arrangement of the computer according to the present embodiment.

### DESCRIPTION OF EXEMPLARY EMBODIMENTS

Hereinafter, the present invention will be described through embodiments of the invention, but the following embodiments do not limit the invention according to the claims. In addition, not all of the combinations of features described in the embodiments are essential to the solution of the invention.

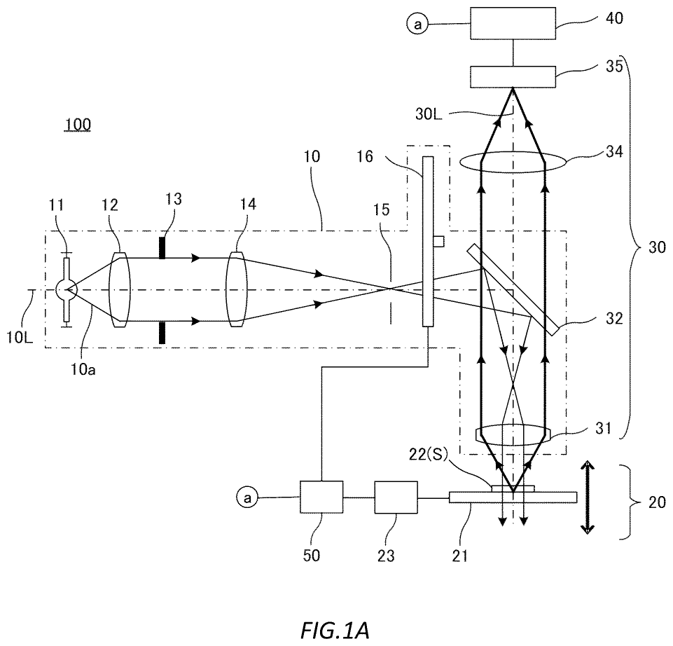

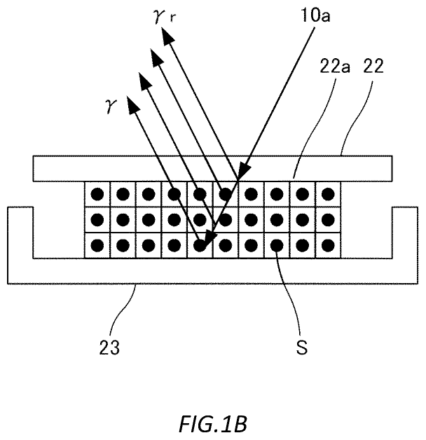

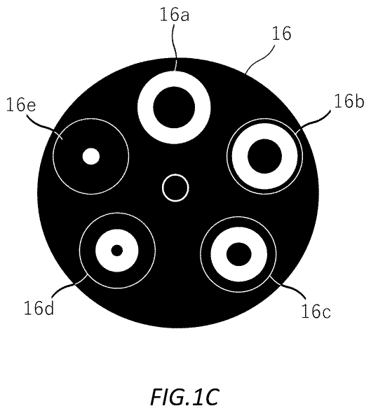

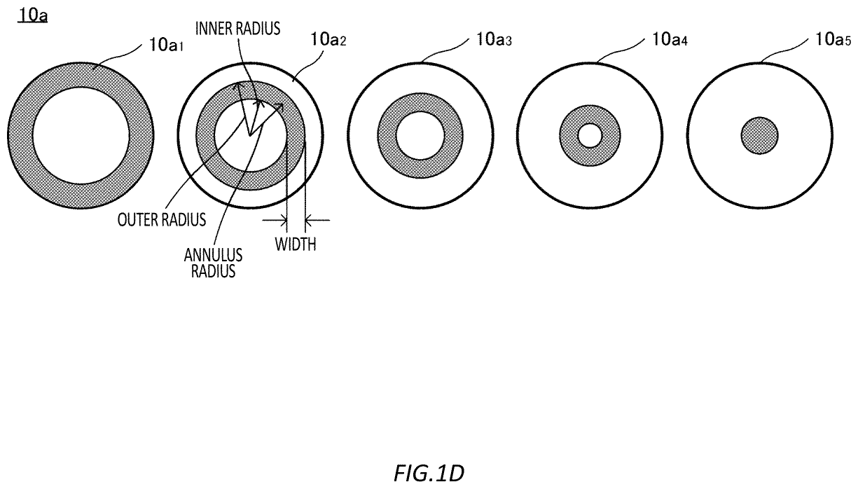

FIG. 1A shows a schematic arrangement of the bright-field reflection microscope (unless otherwise stated, simply referred to as a microscope) 100 according to the present embodiment. FIG. 1B shows that when the sample S is illuminated, the reflected light γ from the sample S and the reflected light γᵣ from the interface 22a of the surroundings (as an example, the cover glass 22) of the sample S are generated. The microscope 100 is a device that illuminates the sample S with the illumination light 10a, receives the reflected light γ from the sample S which is affected by the structure of the sample S together with the reflected light γᵣ from the interface of the surroundings of the sample S, as an example, the interface 22a of the cover glass 22 holding the sample S, which is not affected by the structure of the sample S, and detects the interference between them, to generate a three-dimensional image of the sample S in the real space and includes an illumination optical system 10, a driving unit 20, a detection optical system 30, and a processing unit 40. Herein, the optical axis of a part of the illumination optical system 10 is referred to as an optical axis 10L and the optical axis of the detection optical system 30 (an objective lens) is referred to as an optical axis 30L. The sample S located within a container 23 or on a slide glass (not illustrated) is held by a holding member such as a cover glass 22 and is retained on a stage 21.

The sample S is, for example, a cell section, a cell spheroid, an organoid, or the like. The cell spheroid refers to a three-dimensional clump of cells subjected to three-dimensional culture and the organoid refers to a collection of cells that partially include the characteristics of an organ and are small and simplified. The organoid can be three-dimensionally produced in vitro by allowing cells to differentiate while controlling the condition for cell culture by using, as material, pluripotent stem cells such as iPS cells or ES cells, for example. In addition, the sample S includes two or more stacked layers of the cells spreading two-dimensionally (for example, a cell sheet). The cell sheet may be a single layer or may be multiple layers stacked together.

The illumination optical system 10 is an optical system that generates each of a plurality of annular illumination lights 10a having annulus radiuses different from each other and illuminates the sample S with the illumination light 10a, and includes a light source 11, a collector lens 12, a field stop 13, a condenser lens 14, an aperture stop 15, an aperture pattern turret 16. a beam splitter 32 (for example, a half mirror), and an objective lens 31, which are sequentially located on the optical axis 10L.

The light source 11 generates, for example, the illumination light 10a that is incoherent, as the illumination light 10a. For the light source 11, an incoherent surface light source such as a halogen lamp or an LED is desirable.

The collector lens 12 is a lens element that shapes the illumination light 10a generated from each point of the light source 11 into a parallel light.

The field stop 13 is an element that limits the illumination light 10a to limit the observation range of the sample S.

The condenser lens 14 is a lens element that gathers the illumination light 10a via the field stop 13.

The aperture stop 15 is an element that limits the illumination light 10a emitted by the condenser lens 14 to adjust the numerical aperture of the illumination optical system 10. The brightness of the field of view can be changed by adjusting the aperture stop 15. In the present embodiment, the aperture pattern turret 16 is located near the aperture stop 15.

FIG. 1C shows a schematic arrangement of the aperture pattern turret 16. The aperture pattern turret 16 is arranged to be able to be equipped with a plurality of elements and is equipped with a plurality of elements (herein, five elements 16a, 16b, 16c, 16d, 16e, as an example) on which the annular aperture patterns (shown with white color) having annulus radiuses different from each other are formed. The control unit 50 rotates the aperture pattern turret 16 so that the elements on which the annular aperture patterns having annulus radiuses different from each other are formed are sequentially located on the optical axis 10L and the illumination light 10a passes through the aperture pattern, resulting in the illumination light 10a being shaped into a plurality of annular illumination lights (that is, annulus illumination) 10aᵢ having annulus radiuses different from each other.

When the light source 11 emits the illumination light 10a, the illumination light 10a is shaped into parallel light by the collector lens 12, is limited by the field stop 13, then is gathered by the condenser lens 14, and is limited by the element on which an annular aperture pattern is formed to be shaped into an annulus with a predetermined size (radius and width), and thus the annulus illumination 10aᵢ is shaped. The illumination light 10a from the annulus illumination 10aᵢ is partially reflected by a beam splitter 32 located on the intersection of the optical axis 10L of a part of the illumination optical system 10 (the condenser lens 14) and the optical axis 30L of the detection optical system 30 (the objective lens 31) and is transmitted to the sample S via the objective lens 31. Thus, the sample S is illuminated with the illumination light 10a.

FIG. 1D shows the shape of the cross-section of the illumination light 10a generated by the element on which the annular aperture pattern is formed. The illumination light 10a is shaped into the annulus illumination 10a₁-10a₅ having a plurality of (herein five, for example) annulus patterns. The annulus illuminations 10a₁-10a₄ each have different radiuses (the radius of the center of the annulus, which is referred to as an annulus radius) and widths extending outwardly and inwardly about the radius. Herein, the radius of the outer annulus pattern is referred to as an outer radius, and the radius of the inner annulus pattern is referred to as an inner radius. The outer radius of the annulus illumination 10a₁ is equal to (may be smaller than) the maximum radius of the effective light source (referring to the light source image formed at the aperture stop 15). The outer radius of the annulus illumination 10a₂ is greater than (or may be equal to or a little less than) the inner radius of the annulus illumination 10a₁. The outer radius of the annulus illumination 10a₃ is greater than (or may be equal to or a little less than) the inner radius of the annulus illumination 10a₂. The outer radius of the annulus illumination 10a₄ is greater than (or may be equal to or a little less than) the inner radius of the annulus illumination 10a₃. The annulus illumination 10a₅ is in a circular shape and the radius is greater than (or may be equal to or a little less than) the inner radius of the annulus illumination 10a₄. In other words, the annulus illuminations 10a₁-10a₅ are overlapped to cover the effective light source with a maximum distribution.

Although the annulus illumination 10a₅ is in a circular shape, it can be regarded as an annulus illumination with an inner radius being zero by assuming that the inner radius is zero. Since the inner radius is assumed to be zero, the annulus radius is half of the outer radius.

For the number of the annulus illuminations, the annulus radius, and the width, as long as the range of the effective light source can be roughly covered, the number (M) may be at least two, the annulus radiuses may be at approximately equal intervals, including the maximum radius of the effective light source, and the width may be the width that causes the annulus illuminations inwardly and outwardly adjacent to overlap with each other, to interpose a gap without being overlapped or causes the inner annulus to match the inner side of the outer annulus.

Although in the microscope 100 according to the present embodiment, the control unit 50 sequentially switches the plurality of elements (16a-16e) which are located on the aperture pattern turret 16 and on which the annular aperture patterns having annulus radiuses different from each other are formed to generate the annulus illumination 10aᵢ, instead, the annulus illumination 10aᵢ may be generated by arranging the space modulation element (for example, a liquid crystal panel) at a position coupled to the pupil of the objective lens 31 (near the aperture stop 15) and controlling the voltage value applied to the space modulation element (the liquid crystal panel) with the control unit 50 to modulate the illumination light 10a. In addition, the annulus illumination 10aᵢ may be directly generated by arranging the micro LED light source array as the light source 11.

The driving unit 20 is a unit that drives the sample S in the direction of its optical axis 30L relative to the objective lens 31 and has a stage 21 and a drive device 23.

The stage 21 retains the container 23 or the slide glass and is configured to be able to move up and down, along at least the optical axis 30L, the sample S located within the container 23 or on the slide glass and the cover glass (an example of the holding member) 22 holding it.

The drive device 23 drives the stage 21 in at least the direction of the optical axis 30L. As the drive device 23, for example, an electric motor or the like can be employed. The drive device 23 is controlled by the control unit 50 to drive the stage 21 to a target position. Thus, the sample S on the stage 21 moves along the optical axis 30L.

The sample S may be moved along the optical axis 30L relative to the objective lens 31 by using the drive device 23 to drive the objective lens 31 along the optical axis 30L instead of using the drive device 23 to drive the stage 21 along the optical axis 30L.

The detection optical system 30 is a unit that receives the reflected light γ from the sample S to capture the sample S and includes an objective lens 31, a beam splitter 32, an imaging lens 34, and a capturing device 35.

The objective lens 31 is an optical system that illuminates the sample S on the stage 21 by guiding the illumination light 10a and gathers the reflected light γ from the sample S and the reflected light γᵣ from the interface 22a of the surroundings of the sample S, and includes a plurality of lens element in its lens barrel. In the present embodiment, the objective lens 31 is located directly above the stage 21. The objective lens 31 may be configured to be able to move along the optical axis 30L.

The beam splitter 32 is an optical element that reflects a part of the illumination light 10a toward the objective lens 31 and allows a part of the reflected light γ from the sample S to pass therethrough, sending it to the capturing device 35.

The imaging lens 34 gathers the reflected light γ sent via the objective lens 31 on the reception plane of the capturing device 35, on which the image of the sample S is generated.

The capturing device 35 detects the reflected light γ from the sample S via the objective lens 31 and the imaging lens 34 to capture the image of the sample S. The capturing result is sent to the processing unit 40. As the capturing device 35, capturing elements such as a charge coupled device (CCD), a CMOS sensor, or the like may be employed.

When the reflected light γ is emitted from the illuminated sample S, the reflected light γ is gathered by the objective lens 31 together with the reflected light γᵣ from the interface 22a, passes through the beam splitter 32, is gathered by the imaging lens 34, and is detected by the capturing device 35. Thus, the image of the sample S from the reflected light γ is captured.

Although in the microscope 100 according to the present embodiment, the illumination optical system 10 and the detection optical system 30 are located above the stage 21 and the sample S, they may be located below the stage 21 and the sample S. In this case, the sample S located within the container 23 or on the slide glass on the stage 21 is illuminated from below with the illumination light 10a via the objective lens 31, and the reflected light γ from the sample S and the reflected light from the interface between the sample S and the bottom surface of the container 23 or the slide contacting the sample S are gathered via the objective lens 31.

Using each of the plurality of annulus illuminations 10aᵢ, the processing unit 40 processes a plurality of capturing results obtained, by the detection optical system 30, at each of the plurality of positions related to the direction of the optical axis 30L of the sample S by using a parameter related to the plurality of annulus illuminations 10aᵢ, to generate the three-dimensional image of the sample S. The detail of the process of the capturing result will be described below.

The processing unit 40 is a computer device such as a personal computer and is implemented with a device having at least a central processing unit (CPU). The CPU executes a dedicated program to cause the processing unit 40 to process the capturing result and exhibit the function of generating the image of the sample S. The dedicated program is stored in, for example, a ROM and is read by the CPU, or is stored in the storage media such as a DVD-ROM, is read by the CPU by using a reader such as a DVD-ROM drive, and is deployed in a RAM to be activated. Note that, the hardware configuration of the computer device will be described in more detail later with reference to an example.

The control unit 50 controls the driving unit 20 (the drive device 23) to drive the stage 21 (or the objective lens 31) at least in the direction of the optical axis 30L. In the Z stack capturing, the control unit 50 determines the target driving amount (a Z step amount) to the next Z stack position. When the drive device 23 receives the target driving amount from the control unit 50, it drives the stage 21 (or the objective lens 31) by its target driving amount. In this way, the sample S on the stage 21 sequentially moves along the optical axis 30L by the target driving amount so that the observation plane within the sample S is changed to the next Z stack position. The control unit 50 controls the detection optical system 30 (the capturing device 35) to capture the sample at each Z stack position. In this way, the Z stack image is obtained as an object image.

The control unit 50 is a computer device such as a personal computer and is implemented with a device having at least a central processing unit (CPU). The CPU executes the dedicated program to cause the control unit 50 to exhibit the function of controlling each portion constituting the microscope 100. The dedicated program is stored in, for example, a ROM and is read by the CPU, or is stored in the storage media such as a DVD-ROM, is read by the CPU by using a reader such as a DVD-ROM drive, and is deployed in a RAM to be activated. Note that, the hardware configuration of the computer device will be described in more detail later with reference to an example. In addition, the control unit 50 may be implemented with a single computer device, together with the processing unit 40.

The cause of the spurious resolution of the three-dimensional image occurring in the bright-field reflection microscope will be described.

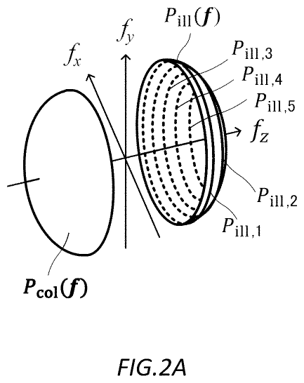

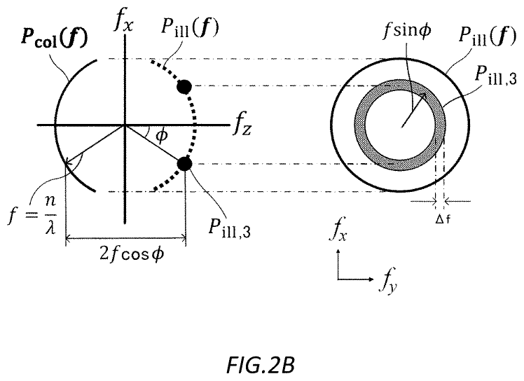

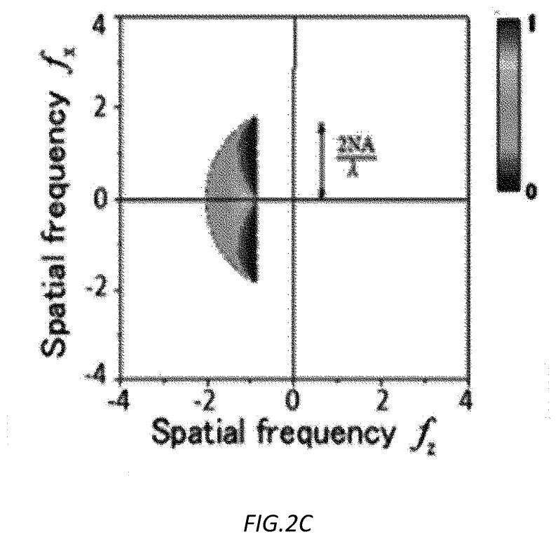

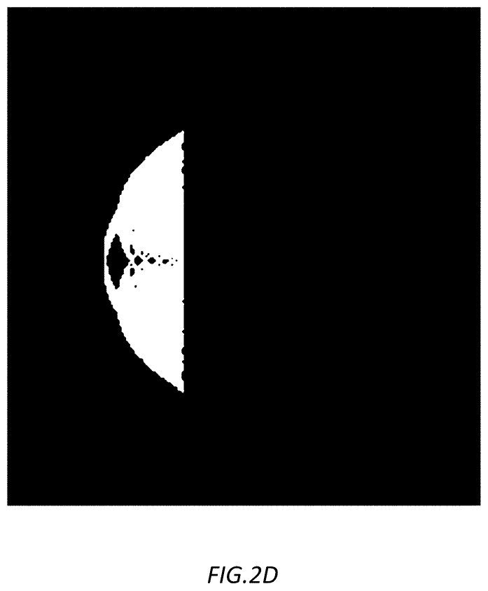

FIG. 2A shows a three-dimensional shape (pupil function) of the imaging pupil P_{col}(f) and the illumination pupil Pᵢₗₗ(f) in the case of the frequency space f{=(fx, fy, fz)}. The imaging pupil is the incoming pupil of the detection optical system 30 and the numerical aperture of the detection optical system 30 is limited by the objective lens 31. In addition, the illumination pupil is the emitting pupil of the illumination optical system 10 and the numerical aperture of the illumination optical system 10 is limited by the aperture stop 15. Herein, for the three-dimensional variants fx, fy, fz in the frequency space f, fz is the spatial frequency relative to the direction of the optical axis 10L (Z direction), and fx and fy are spatial frequencies relative to the position on the plane orthogonal to the optical axis 10L (the positions in X direction and Y direction). The convolution of the imaging pupil P_{col}(f) and the illumination pupil Pᵢₗₗ(f) gives A(f){=P_{col}(f)·Pᵢₗₗ(f)} representing the three-dimensional aperture. In this example, it is assumed that the numerical aperture (hereinafter, referred to as NA) of the illumination optical system is equal to that of the detection optical system.

The imaging pupil P_{col}(f) has a partial sphere shell shape cut out by the NA that is axial symmetry with respect to the fz axis and has the top pointed to the −fz direction. The illumination pupil Pᵢₗₗ(f) has a partial sphere shell shape that is axial symmetry with respect to the fz axis and has the top pointed to the +fz direction. The sphere shell radiuses f of the imaging pupil and the illumination pupil are obtained using the following formula: f=n/λ. Note that n is the average refractive index of the inside of the specimen (the inside of the sample S) and λ is the wavelength of the illumination light 10a.

By slicing the illumination pupil Pᵢₗₗ(f) into M pieces in perpendicular to the fz axis (in parallel with the fx-fy plane), a plurality of (M) annular annulus pupils P_{ill,i}(f) (i=1 to M) having radiuses f sin φₘₐₓ(=NAᵢₗₗ/λ) different from each other (referred to as annulus radiuses) are obtained. φₘₐₓ is a possible maximum angle of φ. The annulus radius of the ith annulus pupil P_{ill,i} may be given as (NAᵢₗₗ/λ)(i−1)/(M−1). i is any of 1 to M. The NAᵢₗₗ of the Mth annulus pupil P_{ill,M} is preferably equal to or closer to the NA of the imaging pupil (however, desirably 0.9 times or more). In this way, a high resolution can be obtained.

The annulus width Δf may be infinitesimal or may be a width that barely overlaps with or is separated from the inwardly and outwardly adjacent annulus pupil, as long as the whole annulus pupil P_{ill,i} can roughly cover the illumination pupil Pᵢₗₗ(f). For example, NAᵢₗₗ/2λ≤MΔf≤NAᵢₗₗ/λ may be met. Thus, a small number (M) of the annuluses can cover roughly whole the illumination pupil Pᵢₗₗ(f) so that a high resolution can be obtained.

In principle, the number (M) of the annulus illuminations is desirably a large number so that whole the observable region is covered. As in FIG. 2D showing the three-dimensional aperture in the case of the number M of annuluses being five, approximately five annuluses can roughly cover the ideal observable region shown in FIG. 2C.

FIG. 2B shows the fx-fz and fx-fy two-dimensional shapes (the pupil function) of the imaging pupil P_{col}(f) and the illumination pupil Pᵢₗₗ(f) in the frequency space f, for example, the annulus pupil P_{ill,3}(f). The annulus radius of the annulus pupil P_{ill,3}(f) is 0.4f. The distance 2f cos φᵢ between the annulus pupil P_{ill,i} and the imaging pupil P_{col}(f) related to the fz direction is determined as a parameter related to the annulus illumination 10aᵢ (also referred to as an annulus parameter).

FIG. 2C shows the three-dimensional aperture A(f) given by the convolution P_{col}(f)·Pᵢₗₗ(f) of the imaging pupil P_{col}(f) and the illumination pupil Pᵢₗₗ(f). The three-dimensional aperture A(f) gives an observable object frequency region (that is, the existence region of the image frequency). The three-dimensional aperture A(f) is a three-dimensional function that is distributed in the −fz region on the fx-fz plane as shown in the figure and is rotational symmetry with respect to the fz axis. An ideal image frequency can be obtained by causing the reflected light γ from the sample S to interfere with the light transmitted along the optical path that is independent of the optical axes 10L and 30L, that is, the reference light that does not change the phase when the stage 21 holding the sample S is driven. However, when the reflected light γ from the sample S interferes with the reflected light γᵣ from the interface of the surroundings of the sample S, for example, the interface 22a of the cover glass 22 holding the sample S, the spurious resolution occurs in the three-dimensional image because, for example, the stage 21 holding the sample S is driven to obtain the Z stack image and thus the phase of the reflected light γᵣ changes.

FIG. 2D shows a three-dimensional aperture ΣᵢAᵢ(f) in the case of the number M of annuluses being five. It can be seen that the ideal observable region shown in FIG. 2C is roughly covered.

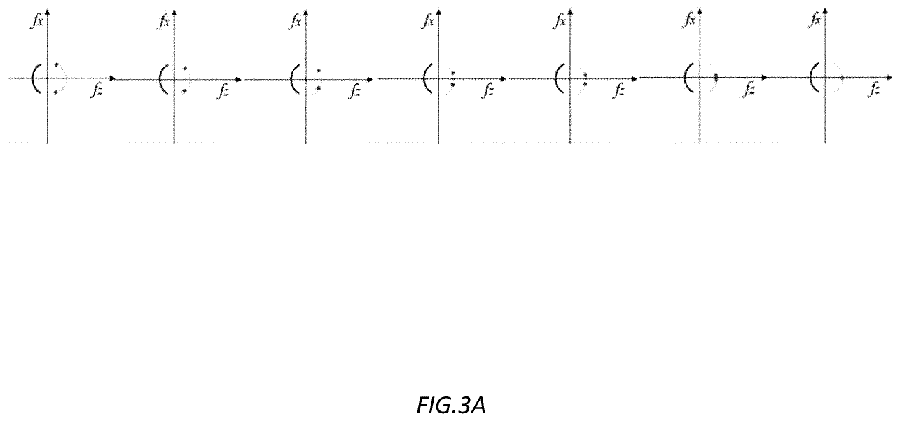

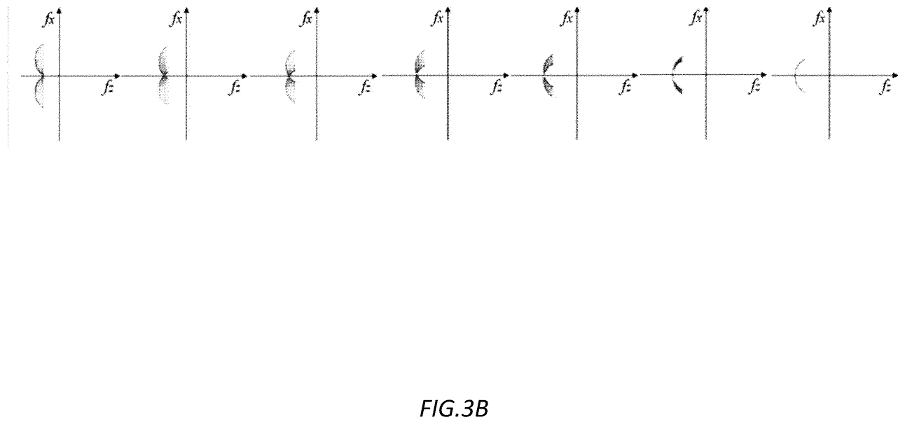

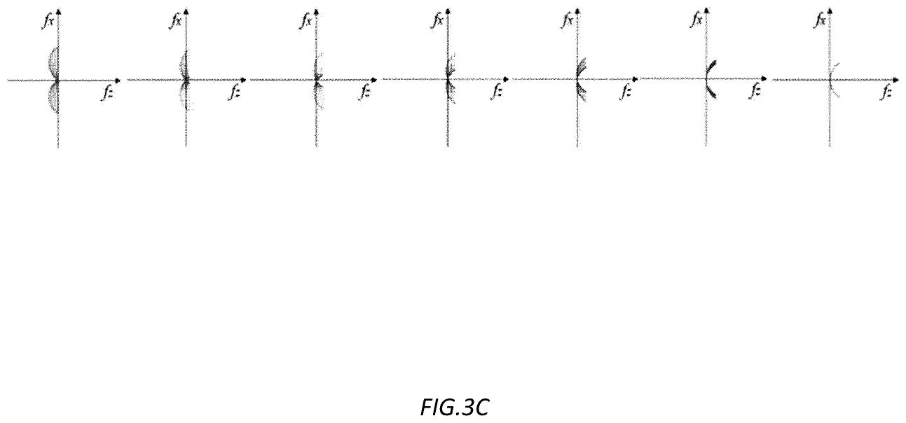

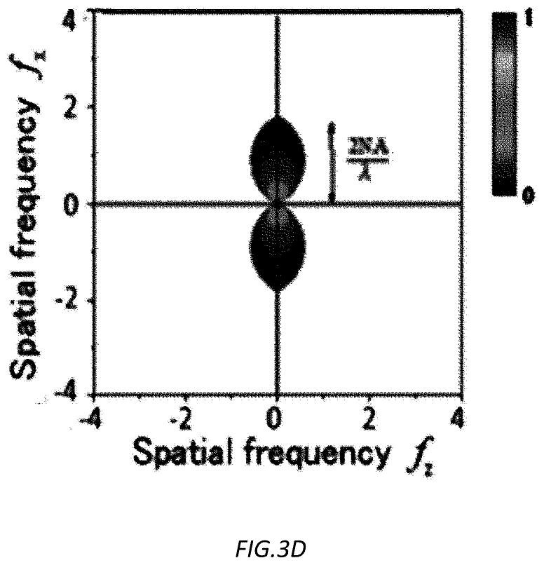

FIG. 3A shows an example of the set of the imaging pupil P_{col}(f) and the plurality (M) of annulus pupils P_{ill,i} with annulus radiuses different from each other obtained by dividing the illumination pupil Pᵢₗₗ(f) as described above (i=1 to 7, from right to left in the figure), based on FIG. 2B. Herein, it is assumed that M=7, as an example. The annulus width Δf is a sufficiently small value and the annulus pupil P_{ill,i} (i=2 to 7) is distributed in a ring shape (two points on the fx-fz plane) in the frequency space. P_{ill,1} is distributed on one point on the fz axis.

FIG. 3B shows the three-dimensional aperture Aᵢ(f) of the annulus illumination obtained from each set of the imaging pupil P_{col}(f) and the annulus pupil P_{ill,i} shown in FIG. 3A (i=1 to 7, right to left in the figure). The three-dimensional aperture Aᵢ(f) is located in the −fz region.

However, because driving the stage 21 holding the sample S changes the phase of the reflected light γᵣ from the interface of the surroundings of the sample S with which the reflected light γ from the sample S interferes, for example, the interface 22a of the cover glass 22 holding the sample S, the image frequency obtained by each annulus illumination 10aᵢ shifts toward the origin in the +fz direction by the shift amount given by the annulus parameter 2f cos φᵢ as schematically shown in FIG. 3C. The shift amount varies for each annulus illumination 10aᵢ.

FIG. 3C shows the three-dimensional aperture Bᵢ(f) (including the spurious resolution) from the annulus illumination 10aᵢ obtained by shifting each of the three-dimensional apertures Aᵢ(f) of the annulus illuminations 10aᵢ shown in FIG. 3B in the +fz direction by the shift amount given by the annulus parameters 2f cos φᵢ.

FIG. 3D shows the total sum of the annulus illuminations Bᵢ(f) shown in FIG. 3C (i=1 to 7). This total sum gives the object frequency (that is, the frequency distribution of the object image) that is observable in the bright-field reflection microscope. It can be seen that it has significantly collapsed from the three-dimensional aperture A(f) shown in FIG. 2C. In other words, in the bright-field reflection microscope, the sample S is usually illuminated with illumination, and the reflected light γ from the sample S affected by the structure of the sample S interferes with the reflected light γᵣ from the interface of the surroundings of the sample S not affected by the structure of the sample S, for example, the interface 22a of the cover glass 22 holding the sample and is received by the detection optical system 30. Herein, the reflected light γ from the sample S interferes with the reflected light γᵣ from the interface 22a moving along with the sample S and thus the spurious resolution occurs and the three-dimensional image not correctly affected by the object structure of the sample S is formed.

The image processing method for generating the three-dimensional image of the sample S performed by the microscope (the bright-field reflection microscope) 100 according to the present embodiment is described.

The image processing method is performed by the processing unit 40. For each used annulus illumination 10aᵢ (i=1 to M), the processing unit 40 generates the object image (also referred to as an image frequency) in the frequency space f from the plurality of capturing results obtained at each of the plurality of positions related to the direction of the optical axis 30L of the sample S, processes it by using the annulus parameter related to the annulus radius of the used annulus illumination 10aᵢ, synthesizes the obtained plurality of image frequencies, and performs an inverse Fourier transform, thereby generating the three-dimensional image of the sample S in the real space.

The image frequency of the sample S for each annulus illumination 10aᵢ in the frequency space f is obtained by performing a Fourier transform on the image of the sample S obtained by using each annulus illumination 10aᵢ into the frequency space f. Herein, it is assumed that the image frequency for each annulus illumination 10aᵢ has been already obtained. The procedure of the observation method to obtain the image frequency of the sample S will be described below.

First, the processing unit 40 divides the illumination pupil Pᵢₗₗ(f) shown in FIG. 2A and FIG. 2B into M pieces to generate the annulus pupils P_{ill,i} (i=1 to M). Herein, as an example, it is assumed that M=6. Thus, as shown in FIG. 3A, the set of the imaging pupil P_{col}(f) and the plurality of annulus pupils P_{ill,i} having annulus radiuses different from each other is obtained.

Then, the processing unit 40 calculates the convolution of each set of the imaging pupil P_{col}(f) and the annulus pupil P_{ill,i}. Thus, the three-dimensional aperture Aᵢ(f) of each annulus illumination 10aᵢ as shown in FIG. 3B is obtained (the information of the sample S is not included and the theoretical value determined only by the optical system is obtained).

Then, the processing unit 40 shifts each of the three-dimensional apertures Aᵢ(f) of the annulus illuminations 10aᵢ in the +fz direction by the shift amount given by the annulus parameter 2f cos φᵢ. Thus, the three-dimensional aperture Bᵢ(f) of each annulus illumination 10aᵢ as shown in FIG. 3C is obtained (a part of the frequency region that can be obtained by the annulus illumination calculated through a theoretical calculation is obtained).

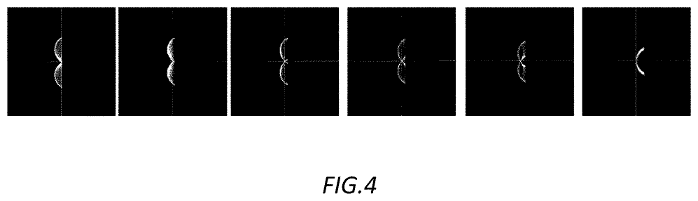

Then, the processing unit 40 calculates the imaginary part of iBᵢ(f)−iBᵢ*(−f) by using the three-dimensional aperture Bᵢ(f) of each annulus illumination 10aᵢ and extracts only its positive value part (defined as α(f)) (theoretical calculation). Thus, the positive-definite function (α(f)) in which only the extracted positive value part is one and the other parts are zero is obtained, as shown in FIG. 4.

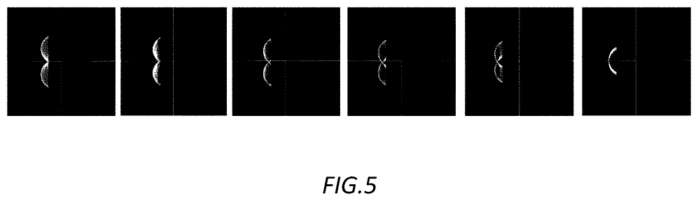

Then, the processing unit 40 extracts only the region of α(f) calculated above among the image frequency (the measured value) of the sample S generated for each annulus illumination 10aᵢ (only the region corresponding to the positive value part is extracted from the measured value). Then, the processing unit 40 shifts the extracted part in the −fz direction by the shift amount given by the annulus parameter 2f cos φᵢ. The function obtained as a result of the shifting is defined as the image frequency iA′ᵢ(f). It is expressed as a figure in FIG. 5. However, for convenience, it is illustrated without including the object frequency of the sample S.

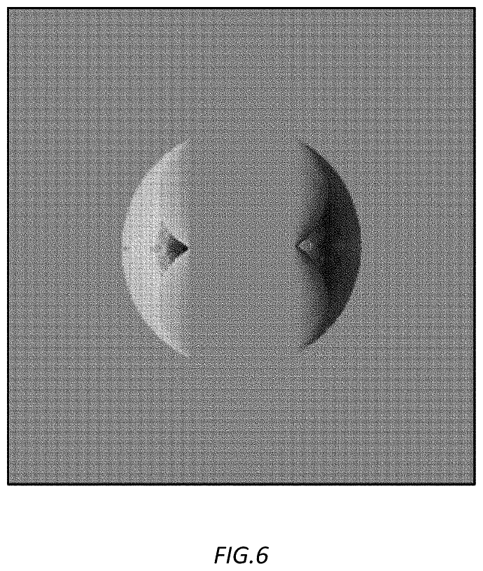

Then, the processing unit 40 converts the image frequency iA′ᵢ(f) obtained above into {iA′ᵢ(f)−iA′*ᵢ(−f)} and synthesizes the image frequency for each annulus illumination 10aᵢ, that is, calculates the total sum Σᵢ{iA′ᵢ(f)−iA′*ᵢ(−f)}. Thus, the distribution of the object frequency of the observable phase object as shown in FIG. 6 is obtained. This is equal to the ideal object frequency (FIG. 2C) obtained by causing the reflected light γ from the sample S to interfere with the light transmitted on the optical path independent of the optical axes 10L and 30L, that is, the reference light that does not change the phase when the stage 21 holding the sample S is driven.

Herein, the overlapping part of iBᵢ(f) and −iBᵢ*(−f) for each annulus illumination 10aᵢ becomes a pure imaginary number as a result of the subtraction, and the information about the real part is lost. Therefore, the processing unit 40 compensates (or restores) the image frequency iA′ᵢ on the fz axis (fz=0) by using the value of the image frequency iA′ᵢ (fz≠0) not on the fz axis. Herein, the compensation process such as the linear compensation, the spline compensation, or the like may be applied or the estimation process such as Bayes' estimation may be applied. Furthermore, the processing unit 40 may compensate (or restore) the image frequency iA′ᵢ(f) on the fx-fy plane by using the value of the image frequency not on the fx-fy plane. Thus, iA′ᵢ(f) can be more correctly restored.

Finally, the processing unit 40 performs a Fourier transform on the object frequency of the phase object obtained above into the real space. Thus, the three-dimensional image of the sample S in the real space is obtained.

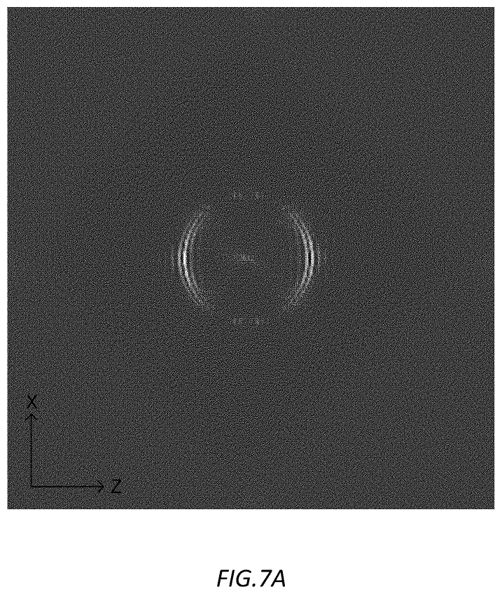

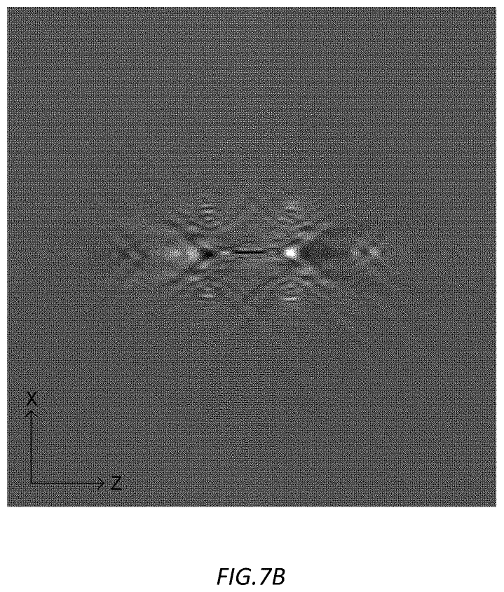

FIG. 7A and FIG. 7B each show the object image reconstructed by the image processing method according to the present embodiment and the object image according to the comparative example. As the sample S, solid micron-sized polystyrene beads are used. According to the object image shown in FIG. 7A, it can be seen that the three-dimensional shape of the sample S is reproduced almost correctly. In contrast, according to the object image shown in FIG. 7B, it can be seen that the spurious resolution occurs as a result of the image processing method according to the present embodiment not being applied and the three-dimensional shape of the sample S cannot be reproduced.

Although in the image processing method described above, the image frequency in the case of the sample S being the phase object is calculated by converting the image frequency iA′ᵢ(f) into {iA′ᵢ(f)−iA′*ᵢ(−f)} and synthesizing the image frequency for each annulus illumination 10aᵢ, instead, the image frequency in the case of the sample S being the absorbing object may be calculated by converting the image frequency iA′ᵢ(f) into {−A′ᵢ(f)−A′*ᵢ(−f)} and synthesizing the image frequency for each annulus illumination 10aᵢ.

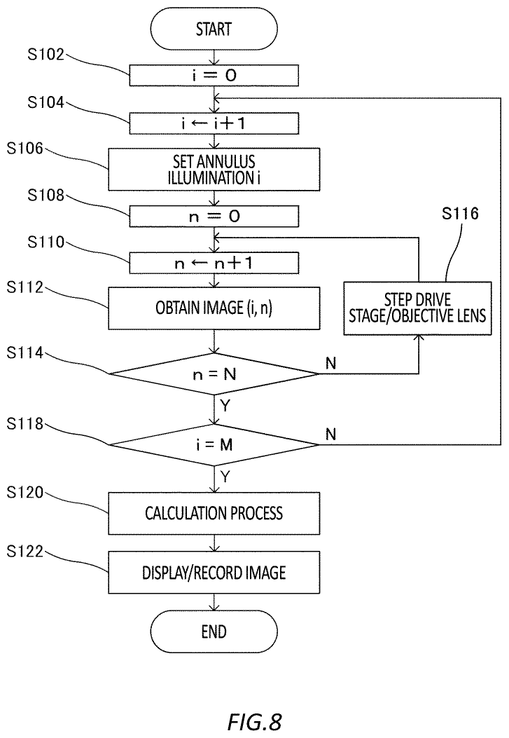

FIG. 8 shows the flow of the observation method for generating the three-dimensional image of the sample S by using the microscope 100 according to the present embodiment. It is assumed that the number M of the annulus illuminations, the number of the Z stack images, that is, the number N of step driving the stage 21 holding the sample S in the direction of the optical axis 30L, and the driving amount are predetermined.

In step S102, the control unit 50 resets the index i (i=0).

In step S104, the control unit 50 increments the index i (adds 1 to i).

In step S106, the control unit 50 generates the illumination light 10a by using the plurality of annulus illuminations 10aᵢ having annulus radiuses different from each other, which is herein the ith annulus illumination 10aᵢ. The method for generating the annulus illumination 10aᵢ is described above.

In step S108, the control unit 50 resets the index n (n=0).

In step S110, the control unit 50 increments the index n (adds 1 to n).

In step S112, the control unit 50 captures the sample S. The control unit 50 first controls the illumination optical system 10 to generate the annulus illumination 10aᵢ and guides it via the objective lens 31 to illuminate the sample S held on the stage 21. Then, the control unit 50 controls the detection optical system 30 to receive the reflected light γ from the sample S and the reflected light γᵣ from the interface of the surroundings of the sample S via the objective lens 31 to capture the sample S. The capturing result (i, n) is sent to the processing unit 40.

In step S114, the control unit 50 determines whether n is equal to N. If it is equal, the process proceeds to step S118. If it is not equal, the process proceeds to step S116.

In step S116, the control unit 50 controls the driving unit 20 to perform the step driving on the stage 21 holding the sample S in the direction of the optical axis 30L by the determined step amount relative to the objective lens 31. Instead of driving the stage 21, the objective lens 31 may be step-driven in the direction of the optical axis 30L.

When step S116 is complete, the process goes back to step S110. The capturing in step S112 and the step driving in step S116 are repeated until the determination in step S114 is confirmed. Thus, the sample S is captured at each of the plurality of positions related to the direction parallel to the optical axis 30L by using the annulus illumination 10aᵢ. In other words, the Z stack image is obtained.

In step S118, the control unit 50 determines whether i is equal to M. If it is equal, the process proceeds to step S120. If it is not equal, the process goes back to step S104.

Until the determination in step S118 is confirmed, the generation of the annulus illumination 10aᵢ in step S106 and the generation of the Z stack image in steps S112 to 116 are repeated. Thus, the Z stack image of the sample S is obtained by using each of all the annulus illuminations 10aᵢ (i=1 to M).

In step S120, the control unit 50 controls the processing unit 40 to perform the image processing method according to the present embodiment. The processing unit 40 performs a Fourier transform on the plurality of capturing results (the Z stack image) obtained at each of the plurality of positions related to the direction of the optical axis 30L of the sample S in step S112 by using each of the plurality of annulus illuminations 10aᵢ and thereby generates the image frequency in the frequency space. Then, the processing unit 40 processes the image frequency for each of the plurality of annulus illuminations 10aᵢ by using the annulus parameter related to the plurality of annulus illuminations 10aᵢ and performs an inverse Fourier transform to generate the three-dimensional image of the sample S in the real space. The detail of the image processing method is described above.

In step S120, the control unit 50 controls the processing unit 40 to display the obtained three-dimensional image of the sample S on a screen and/or record it in the storage device. Thus, the flow completes.

Although in the observation method according to the present embodiment, the annulus illumination 10aᵢ is generated and the Z stack image is generated by capturing the sample S while the stage 21 holding the sample S is step-driven with respect to the annulus illumination 10aᵢ, instead, the stage 21 holding the sample S is step-driven and is positioned in the direction of the optical axis 30L and the sample S may be captured while the annulus illumination 10aᵢ is sequentially generated with respect to the stage 21.

A microscope 100 according to the present embodiment includes an illumination optical system 10 that includes an aperture pattern turret 16 that can form a plurality of annular illumination lights 10a having annulus radiuses different from each other and an objective lens 31 and illuminates the sample S with the illumination light 10a; a detection optical system 30 that gathers a first reflected light from the sample S and a second reflected light from an interface of surroundings of the sample S at the capturing device 35 via the objective lens 31; and a control unit 50, and the capturing device 35 detects the first reflected light and the second reflected light at each of the plurality of positions with different relative positions to the objective lens 31 and the sample S by using each of the plurality of annular illumination lights 10aᵢ formed by the control unit 50 controlling the aperture pattern turret 16. According to this, a three-dimensional image of a sample without spurious resolution can be generated by using each of the plurality of annular illumination lights 10aᵢ having annulus radiuses different from each other to capture, by the capturing device 35, the sample S at a plurality of positions related to the optical axis direction, generating an image frequency in the frequency space (fx, fy, fz) from a plurality of capturing results (the XY image) obtained at each of the plurality of positions related to the optical axis direction of the sample S (the z direction) for each used annulus illumination 10aᵢ, performs processing by using a parameter related to the annulus radius of the used annulus illumination 10aᵢ, and synthesizing a plurality of image frequencies that are obtained.

The observation method according to the present embodiment includes illuminating the sample S with the illumination light 10a via the illumination optical system 10 including an aperture pattern turret 16 that can form a plurality of annular illumination lights 10a having annulus radiuses different from each other and the objective lens 31; gathering the first reflected light from the sample and the second reflected light from the interface of the surroundings of the sample S at the capturing device 35 via the objective lens 31; and detecting, by the capturing device 35, the first reflected light and the second reflected light at each of the plurality of positions with different relative positions to the objective lens 31 and the sample S by using each of the plurality of annular illumination light 10a formed by controlling the aperture pattern turret 16. According to this, a three-dimensional image of a sample without spurious resolution can be generated by using each of the plurality of annular illumination light 10aᵢ having annulus radiuses different from each other to capture, by the capturing device 35, the sample S at a plurality of positions related to the optical axis direction, generating an image frequency in the frequency space (fx, fy, fz) from a plurality of capturing results (the XY image) obtained at each of the plurality of positions related to the optical axis direction of the sample S (the z direction) for each used annulus illumination 10aᵢ, performs processing by using a parameter related to the annulus radius of the used annulus illumination 10aᵢ, and synthesizing a plurality of image frequencies that are obtained.

The program according to the present embodiment causes a computer to perform illuminating the sample S with the illumination light 10a via the illumination optical system 10 including an aperture pattern turret 16 that can form a plurality of annular illumination lights 10a having annulus radiuses different from each other and the objective lens 31; gathering the first reflected light from the sample and the second reflected light from the interface of the surroundings of the sample S at the capturing device 35 via the objective lens 31; and detecting, by the capturing device 35, the first reflected light and the second reflected light at each of the plurality of positions with different relative positions to the objective lens 31 and the sample S by using each of the plurality of annular illumination light 10a formed by controlling the aperture pattern turret 16. According to this, a three-dimensional image of a sample without spurious resolution can be generated by using each of the plurality of annular illumination light 10aᵢ having annulus radiuses different from each other to capture, by the capturing device 35, the sample S at a plurality of positions related to the optical axis direction, generating an image frequency in the frequency space (fx, fy, fz) from a plurality of capturing results (the XY image) obtained at each of the plurality of positions related to the optical axis direction of the sample S (the z direction) for each used annulus illumination 10aᵢ, performs processing by using a parameter related to the annulus radius of the used annulus illumination 10aᵢ, and synthesizing a plurality of image frequencies that are obtained.

Various embodiments of the present invention may be described with reference to flowcharts and block diagrams whose blocks may represent (1) steps of processes in which operations are performed or (2) sections of devices responsible for performing operations. Certain stages and sections may be implemented by a dedicated circuit, a programmable circuit supplied together with computer-readable instructions stored on computer-readable media, and/or processors supplied together with computer-readable instructions stored on computer-readable media. The dedicated circuit may include digital and/or analog hardware circuits, and may include integrated circuits (IC) and/or discrete circuits. The programmable circuit may include a reconfigurable hardware circuit including logical AND, logical OR, logical XOR, logical NAND, logical NOR, and other logical operations, a memory element or the like such as a flip-flop, a register, a field programmable gate array (FPGA) and a programmable logic array (PLA), or the like.

A computer-readable medium may include any tangible device that can store instructions to be executed by a suitable device, and as a result, the computer-readable medium having instructions stored thereon includes a product including instructions that can be executed in order to create means for executing operations designated in the flowcharts or block diagrams. Examples of the computer-readable medium may include an electronic storage medium, a magnetic storage medium, an optical storage medium, an electromagnetic storage medium, a semiconductor storage medium, and the like. More specific examples of the computer-readable medium may include floppy (registered trademark) disks, diskettes, hard disks, random access memories (RAM), read-only memories (ROM), erasable programmable read-only memories (EPROM or flash memory), electrically erasable programmable read-only memories (EEPROM), static random access memories (SRAM), compact disk read-only memories (CD-ROM), digital versatile disks (DVD), Blu-ray (registered trademark) disks, memory sticks, integrated circuit cards, and the like.

The computer-readable instruction may include: an assembler instruction, an instruction-set-architecture (ISA) instruction; a machine instruction; a machine dependent instruction; a microcode; a firmware instruction; state-setting data; or either a source code or an object code described in any combination of one or more programming languages, including an object oriented programming language such as Smalltalk (registered trademark), JAVA (registered trademark), C++, or the like, and a conventional procedural programming language such as a “C” programming language or a similar programming language.

Computer-readable instructions may be provided to a processor of a general-purpose computer, special purpose computer, or other programmable data processing devices, or to programmable circuitry, locally or via a local area network (LAN), wide area network (WAN) such as the Internet, or the like, so that the computer-readable instructions are executed to create means for performing operations specified in the flowcharts or block diagrams. Examples of the processor include a computer processor, a processing unit, a microprocessor, a digital signal processor, a controller, a microcontroller, and the like.

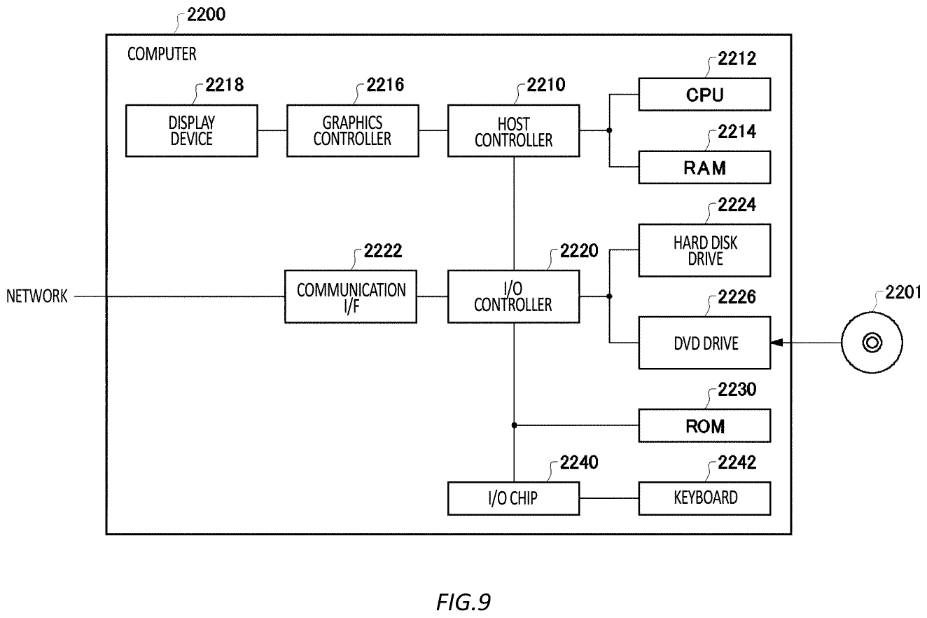

FIG. 9 shows an example of a computer 2200 in which a plurality of aspects of the present invention may be wholly or partly embodied. A program installed in the computer 2200 can cause the computer 2200 to function as an operation associated with the devices according to the embodiments of the present invention or as one or more sections of the devices, or can cause the operation or the one or more sections to be executed, and/or can cause the computer 2200 to execute a process according to the embodiments of the present invention or a step of the process. Such programs may be executed by a CPU 2212 to cause the computer 2200 to perform specific operations associated with some or all of the blocks in the flowcharts and block diagrams described in the present specification.

The computer 2200 according to the present embodiment includes the CPU 2212, a RAM 2214, a graphics controller 2216, and a display device 2218, which are interconnected by a host controller 2210. The computer 2200 also includes input/output units such as a communication interface 2222, a hard disk drive 2224, a DVD-ROM drive 2226, and an IC card drive, which are connected to the host controller 2210 via an input/output controller 2220. The computer also includes legacy input/output units such as an ROM 2230 and a keyboard 2242, which are connected to the input/output controller 2220 via an input/output chip 2240.

The CPU 2212 operates according to programs stored in the ROM 2230 and the RAM 2214, thereby controlling each unit. The graphics controller 2216 acquires image data generated by the CPU 2212 in a frame buffer or the like provided in the RAM 2214 or in itself, such that the image data is displayed on the display device 2218.

The communication interface 2222 communicates with other electronic devices via a network. The hard disk drive 2224 stores programs and data used by the CPU 2212 in the computer 2200. The DVD-ROM drive 2226 reads a program or data from a DVD-ROM 2201 and provides the program or data to the hard disk drive 2224 via the RAM 2214. The IC card drive reads the programs and the data from the IC card, and/or writes the programs and the data to the IC card.

The ROM 2230 stores therein boot programs and the like executed by the computer 2200 at the time of activation, and/or programs that depend on the hardware of the computer 2200. The input/output chip 2240 may also connect various input/output units to the input/output controller 2220 via a parallel port, a serial port, a keyboard port, a mouse port, or the like.

Programs are provided by a computer-readable medium such as the DVD-ROM 2201 or the IC card. The programs are read from the computer-readable medium, are installed in the hard disk drive 2224, the RAM 2214, or the ROM 2230 which is also an example of the computer-readable medium, and are executed by the CPU 2212. The information processing described in these programs is read by the computer 2200, and provides cooperation between the programs and the various types of hardware resources. The device or method may be configured by implementing operations or processing of information according to use of the computer 2200.

For example, in a case where communication is performed between the computer 2200 and an external device, the CPU 2212 may execute a communication program loaded in the RAM 2214 and instruct the communication interface 2222 to perform communication processing based on a processing written in the communication program. Under the control of the CPU 2212, the communication interface 2222 reads transmission data stored in a transmission buffer processing area provided in a recording medium such as the RAM 2214, the hard disk drive 2224, the DVD-ROM 2201, or the IC card, transmits the read transmission data to the network, or writes reception data received from the network in a reception buffer processing area or the like provided on the recording medium.

In addition, the CPU 2212 may cause the RAM 2214 to read all or a necessary part of a file or database stored in an external recording medium such as the hard disk drive 2224, the DVD-ROM drive 2226 (DVD-ROM 2201), the IC card, or the like, and may execute various types of processing on data on the RAM 2214. Then, the CPU 2212 writes the processed data back in the external recording medium.

Various types of information such as various types of programs, data, tables, and databases may be stored in a recording medium and subjected to information processing. The CPU 2212 may execute, on the data read from the RAM 2214, various types of processing including various types of operations, information processing, conditional judgement, conditional branching, unconditional branching, information retrieval/replacement, or the like described throughout the present disclosure and specified by instruction sequences of the programs, and writes the results back to the RAM 2214. In addition, the CPU 2212 may retrieve information in a file, a database, or the like in the recording medium. For example, when a plurality of entries, each having an attribute value of a first attribute associated with an attribute value of a second attribute, is stored in the recording medium, the CPU 2212 may retrieve, out of the plurality of entries, an entry with the attribute value of the first attribute specified that meets a condition, read the attribute value of the second attribute stored in said entry, and thereby acquiring the attribute value of the second attribute associated with the first attribute meeting a predetermined condition.

The programs or software modules described above may be stored in a computer-readable medium on or near the computer 2200. In addition, a recording medium such as a hard disk or a RAM provided in a server system connected to a dedicated communication network or the Internet can be used as a computer-readable medium, thereby providing a program to the computer 2200 via the network.

While the present invention has been described by way of the embodiments, the technical scope of the present invention is not limited to the scope described in the above-described embodiments. It is apparent to persons skilled in the art that various alterations or improvements can be made to the above-described embodiments. It is also apparent from the described scope of the claims that the embodiments added with such alterations or improvements can be included in the technical scope of the present invention.

The operations, procedures, steps, stages, or the like of each process performed by a device, system, program, and method shown in the claims, specification, or drawings can be performed in any order as long as the order is not indicated by “prior to,” “before,” or the like and as long as the output from a previous process is not used in a later process. Even if the operation flow is described using phrases such as “first” or “then” in the claims, specification, or drawings, it does not necessarily mean that the process must be performed in this order.

What is claimed is:

1. A bright-field reflection microscope comprising:
an illumination optical system that has a first member capable of forming a plurality of annular illumination lights having annulus radiuses different from each other and an objective lens and illuminates a sample with an illumination light among the illumination lights,
a detection optical system that gathers, at a detection unit, a first reflected light from the sample and a second reflected light from an interface of surroundings of the sample via the objective lens; and
a control unit,
wherein the detection unit detects the first reflected light and the second reflected light at each of a plurality of positions with different relative positions to the objective lens and the sample by using each of the plurality of annular illumination lights formed by the control unit controlling the first member.

2. The bright-field reflection microscope according to claim 1, wherein the interface is an interface between the sample and a second member contacting the sample.

3. The bright-field reflection microscope according to claim 1, comprising a processing unit that processes a plurality of detection results from the detection unit by using a parameter related to the plurality of annular illumination lights and generates a three-dimensional image of the sample.

4. The bright-field reflection microscope according to claim 2, comprising a processing unit that processes a plurality of detection results from the detection unit by using a parameter related to the plurality of annular illumination lights and generates a three-dimensional image of the sample.

5. The bright-field reflection microscope according to claim 3, wherein the processing unit generates a plurality of image frequencies in a frequency space from the plurality of detection results, processes the plurality of image frequencies by using a value of the parameter, synthesizes a new plurality of image frequencies obtained from a result thereof, and generates a three-dimensional image of the sample.

6. The bright-field reflection microscope according to claim 1, wherein an annulus radius of an annular illumination pupil on a frequency plane corresponding to a two-dimensional plane orthogonal to an optical axis direction of the illumination optical system is defined as (NAᵢₗₗ/λ)(i−1)/(M−1), wherein M is a number of the annular illumination pupil, i is any of 1 to M, NAᵢₗₗ is a numerical aperture of the illumination optical system, and λ is a wavelength of the illumination light.

7. The bright-field reflection microscope according to claim 2, wherein an annulus radius of an annular illumination pupil on a frequency plane corresponding to a two-dimensional plane orthogonal to an optical axis direction of the illumination optical system is defined as (NAᵢₗₗ/λ)(i−1)/(M−1), wherein M is a number of the annular illumination pupil, i is any of 1 to M, NAᵢₗₗ is a numerical aperture of the illumination optical system, and λ is a wavelength of the illumination light.

8. The bright-field reflection microscope according to claim 3, wherein an annulus radius of an annular illumination pupil on a frequency plane corresponding to a two-dimensional plane orthogonal to an optical axis direction of the illumination optical system is defined as (NAᵢₗₗ/λ)(i−1)/(M−1), wherein M is a number of the annular illumination pupil, i is any of 1 to M, NAᵢₗₗ is a numerical aperture of the illumination optical system, and λ is a wavelength of the illumination light.

9. The bright-field reflection microscope according to claim 4, wherein an annulus radius of an annular illumination pupil on a frequency plane corresponding to a two-dimensional plane orthogonal to an optical axis direction of the illumination optical system is defined as (NAᵢₗₗ/λ)(i−1)/(M−1), wherein M is a number of the annular illumination pupil, i is any of 1 to M, NAᵢₗₗ is a numerical aperture of the illumination optical system, and λ is a wavelength of the illumination light.

10. The bright-field reflection microscope according to claim 5, wherein an annulus radius of an annular illumination pupil on a frequency plane corresponding to a two-dimensional plane orthogonal to an optical axis direction of the illumination optical system is defined as (NAᵢₗₗ/λ)(i−1)/(M−1), wherein M is a number of the annular illumination pupil, i is any of 1 to M, NAᵢₗₗ is a numerical aperture of the illumination optical system, and λ is a wavelength of the illumination light.

11. The bright-field reflection microscope according to claim 5, wherein the processing unit:
i) calculates each three-dimensional aperture Bᵢ(f) by shifting a three-dimensional aperture Aᵢ(f) determined from each annular illumination pupil of the illumination optical system and an imaging pupil of the detection optical system in a predetermined direction by a value of the parameter, wherein i is any of 1 to M and M is a number of annular illumination pupils;
ii) calculates a positive-definite function by using the each three-dimensional aperture Bᵢ(f); and
iii) extracts a region of the positive-definite function from the plurality of image frequencies calculated from the plurality of detection results.

12. The bright-field reflection microscope according to claim 11, wherein the processing unit calculates the new plurality of image frequencies by shifting the region that has been extracted in a direction opposite to the predetermined direction by a value of the parameter.

13. The bright-field reflection microscope according to claim 5, wherein the processing unit synthesizes the new plurality of image frequencies as a phase object or an absorbing object.

14. The bright-field reflection microscope according to claim 13, wherein the processing unit compensates the plurality of image frequencies on a frequency axis corresponding to an optical axis direction of the objective lens by using the plurality of image frequencies not on the frequency axis.

15. The bright-field reflection microscope according to claim 1, wherein the first member is a member in which a space modulation element, an LED light source array, or a plurality of annular aperture patterns having annulus radiuses different from each other are located.

16. The bright-field reflection microscope according to claim 2, wherein the first member is a member in which a space modulation element, an LED light source array, or a plurality of annular aperture patterns having annulus radiuses different from each other are located.

17. The bright-field reflection microscope according to claim 3, wherein the first member is a member in which a space modulation element, an LED light source array, or a plurality of annular aperture patterns having annulus radiuses different from each other are located.

18. The bright-field reflection microscope according to claim 4, wherein the first member is a member in which a space modulation element, an LED light source array, or a plurality of annular aperture patterns having annulus radiuses different from each other are located.

19. An observation method, comprising:
illuminating, via an illumination optical system including a first member that can form a plurality of annular illumination lights having annulus radiuses different from each other and an objective lens, a sample with an illumination light among the plurality of illumination lights;
gathering a first reflected light from the sample and a second reflected light from an interface of surroundings of the sample at a detection unit via the objective lens; and
detecting, by the detection unit, the first reflected light and the second reflected light at each of a plurality of positions with different relative positions to the objective lens and the sample by using each of the annular illumination lights formed by controlling the first member.

20. A computer-readable medium having recorded thereon a program which, when executed by a computer, causes the computer to perform operations comprising:
illuminating, via an illumination optical system including a first member that can form a plurality of annular illumination lights having annulus radiuses different from each other and an objective lens, a sample with an illumination light among the plurality of illumination lights;
gathering a first reflected light from the sample and a second reflected light from an interface of surroundings of the sample at a detection unit via the objective lens; and
detecting, by the detection unit, the first reflected light and the second reflected light at each of a plurality of positions with different relative positions to the objective lens and the sample by using each of the annular illumination lights formed by controlling the first member.
